(19) United States
(12) Patent Application Publication
(10) Pub. No.: US 2024/0392686 A1
(43) Pub. Date: Nov. 28, 2024

(54) Methods for Scalable, Mass Production/Manufacturing of Cavitation Reducing Propeller Loop Blades

(71) Applicant: George D. Demirev, Newton, MA (US)

(72) Inventor: George D. Demirev, Newton, MA (US)

(21) Appl. No.: 18/668,158

(22) Filed: May 21, 2024

Related U.S. Application Data
(60) Provisional application No. 63/468,925, filed on May 25, 2023.

(51) Int. Cl. F01D 5/14

(52) U.S. Cl. CPC F01D 5/147; F05D 2230/10

(57) ABSTRACT

This invention relates to methods for creating loop blades (LB) for propellers, using readily available prefabricated and pre-shaped workpieces. The proposed methods leverage existing manufacturing capabilities to simplify LB production. Two methods are disclosed.

The first method utilizes pre-curved tubular or helical workpieces and a single cutting operation to create a variety of LB. Parameters from the LB specifications guide the selection and processing of the pre-curved workpieces with appropriate cutting tools.

The second method employs a single curving operation on pre-cut flat sheets or bars to create LB, extended with straight wings. LB specifications determine the selection and curving parameters for the pre-cut workpieces.

Both methods offer reduced production costs and faster turnaround times of LB production using commercially available components. The application outlines detailed steps for each method and illustrates potential use cases for LB in various propulsion system configurations, emphasizing their adaptability and efficiency.

### CROSS-REFERENCE TO RELATED APPLICATIONS

Provisional Application No 63/468,925 from 2023 May 25.

### PRIOR ART

US20190135410A1 “Toroidal Propeller”

U.S. Pat. No. 4,445,817A “Propeller construction”

U.S. Pat. No. 9,926,058B2 “Propeller”

U.S. Pat. No. 5,096,382A “Ring-shrouded propeller”

### BACKGROUND OF THE INVENTION

The evolution of propeller technology has seen various innovations aimed at enhancing performance, efficiency, and reducing operational challenges. Among these innovations, Cavitation Reducing Propellers (CRP) have garnered significant attention for their potential to mitigate noise, increase power, and improve maneuverability compared to traditional propeller designs. Historically, the idea of CRP has been explored for many years, with patents dating back over a century. Loop blades (LB) have emerged as a particularly promising CRP design, characterized by their unique twisted shapes. However, traditional manufacturing methods such as casting rigid alloys or CNC machining have struggled to effectively produce LB due to their complex geometry. Recent advancements in additive printing and CNC machining technology have revitalized interest in LBs. Notable patents and implementations, such as the “Toroidal Propeller” by MIT (US20190135410A1) and the innovations by Sharrow (U.S. Pat. No. 9,926,058B2), have contributed to advancements in LB design and manufacturing.

The “Toroidal Propeller” patent from MIT introduces a novel propeller design characterized by a toroidal shape, aiming to improve propulsion efficiency and reduce cavitation effects. Meanwhile, Sharrow's patents focus on unique blade designs that aim to reduce drag and increase propulsive efficiency.

Despite these advancements, challenges persist in LB manufacturing. Additive manufacturing methods, while suitable for prototyping, often come with high costs and limited material options for mass production. Similarly, traditional manufacturing techniques like metal casting or CNC machining struggle with the intricate geometry of LBs, leading to limitations in material options and increased manufacturing costs.

Overall, ongoing research and development efforts in propeller technology, including CRP designs like LB, continue to push the boundaries of performance and efficiency in propulsion systems, driving innovation in the maritime, aviation, and renewable energy sectors.

### SUMMARY OF THE INVENTION

This invention describes two novel methods for creating loop blades (LBs) using readily available prefabricated and pre-shaped materials. These methods aim to simplify LB production by leveraging existing manufacturing capabilities.

The first method utilizes pre-curved tubular or helical pieces as starting materials. A single cutting operation, guided by LB specifications, transforms these pre-curved workpieces into LB with a helically twisted shape.

The second method focuses on pre-cut flat sheets or bars. A single curving operation, again guided by LB specifications, shapes these pre-cut elements into LBs with a helically twisted shape, possibly extended with straight wings.

Both methods offer advantages by:
Utilizing readily available prefabricated materials
Requiring only one processing step (cutting or curving)
Tailoring the process based on LB specifications
Overall, this invention presents efficient and streamlined methods for LB production using commercially available components.

### BRIEF DESCRIPTION OF DRAWINGS

All figures are for illustrative purpose made with 3D model program.

FIG. 1 shows a view in different positions of the core part of all loop blade shapes—the helically twisted semi-loop blade.

FIG. 2 Depicts closed pipe, e.g. made by extrusion or rolling, source for closed LBs.

FIG. 3 Depicts open pipe, source for semi and partial LBs.

FIG. 4 Depicts oval pipe, source for winged LBs.

FIG. 5 Depicts helical wrapper shape, source for semi and partial LBs.

FIG. 6 Illustrates a closed pipe after cutting.

FIG. 7 Shows the resulting closed LB and a pair of semi-LBs obtained from the cut pipe.

FIG. 8 Shows an open pipe with cut out slices.

FIG. 9 Shows a semi- and partial LBs from an open pipe.

FIG. 10 illustrates segmented cuts of a helical stripe.

FIG. 11 Shows a semi- and partial LBs from a helical stripe.

FIG. 12 Depicts sliced off oval pipe.

FIG. 13 Shows oval closed LB and a pair of semi-LBs derived from the oval pipe.

FIG. 14 Depicts pre-cut bar, plain strip.

FIG. 15 Depicts pre-cut bar for LB with narrow tip;

FIG. 16 Depicts a cylindrical fixture positioned at LB pitch angle.

FIG. 17 illustrates a curved LB with straight wings.

FIG. 18 illustrates a curved LB with semi-loop shape.

### USE CASE EXAMPLES

FIG. 19 Depicts closed loop blades, assembled in a plane, where each loop axis, coaxial to the rotation axis (coaxial way). The advantage here is their sides are parallel at the point of touch, which allows for greater contact area during assembly, thus providing stronger bond between them;

FIG. 20 Shows closed loop blades attached in coaxial way to a propeller hub.

FIG. 21 Shows closed loop blades, attached to propeller hub, where each loop axis is perpendicular to the rotation axis (perpendicular way).

FIG. 22 Depicts partial open loop blades, attached to propeller hub in perpendicular way.

FIG. 23 Shows semi-loop blades, attached to propeller hub in perpendicular way;

FIG. 24 Shows oval semi-loop blades, attached to propeller hub in coaxial way;

FIG. 25 Shows curved winged semi-loop blades, attached to propeller hub in perpendicular way;

FIG. 26 Shows curved long-winged semi-loop blades, attached to propeller hub in perpendicular way.

### DETAILED DESCRIPTION OF THE INVENTION

### Terminology

Loop Blade (LB): The final product; a twisted blade with a loop-like shape.
Pre-Curved Workpiece: Starting material for Method 1; tubular or helical shapes with defined curvature.
Pre-Cut Workpiece: Starting material for Method 2; flat sheets or bars with defined shapes.
Closed Loop LB: A complete loop.
Partial Loop LB: A loop with any size opening between semi-loop and complete loop.

This invention relates to methods for creating loop blades (LB) utilizing readily available prefabricated and pre-shaped workpieces. The proposed methods for creation of LBs take advantage of existing manufacturing industry, by using widely available pre-fabricated and pre-shaped work pieces. For the purpose of the proposed methods, the pre-fabricated stock (work pieces) is categorized in two main groups: pre-cut and pre-curved. The pre-cut group comprises flat sheet pieces, cut to size and shape, while the pre-curved group includes tubular and helical shaped pieces. Both of these can be easily purchased ready-made or for custom order.

This invention proposes two methods to apply to pre-made work pieces in order to produce LB.

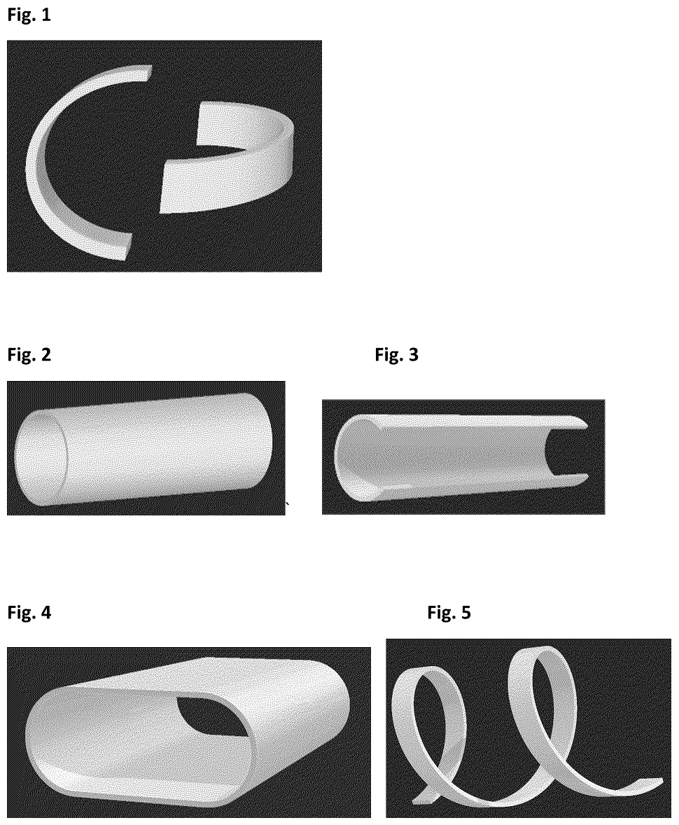

The first method applies a single cutting operation to pre-curved work pieces and the second method applies single curving operation to pre-cut work pieces. The resulting loop blade may have closed loop, semi-loop or partial loop length, where partial length is between semi (50%) and closed (100%) loop length. In essence, in all cases, the core of the resulting LBs is a semi-loop helically twisted shape [FIG. 1]. Modifications thereof can have extended straight or arched wings, depending on the needs.

### Method 1: Utilizing Pre-Curved Workpieces

The first method employs pre-curved tubular or helical shaped workpieces as starting materials. These pre-curved workpieces can be readily obtained commercially or custom-fabricated according to desired specifications.

### Step 1. Selection of Pre-Curved Workpiece

A suitable pre-curved workpiece is selected based on the target LB specifications. Common options for pre-curved workpieces include:

Tubular shapes: These can be closed pipes (e.g., FIG. 2) or open pipes (FIG. 3), with a diameter matching the desired LB diameter and wall thickness corresponding to the intended LB wall thickness. The gap between the pipe ends, if applicable, should be determined based on the LB specifications (e.g., 50% gap for a semi-LB). Oval pipes (e.g. FIG. 4) enable creating winged open LBs via a single cut.

Helical shapes: Helical wrappers (e.g. FIG. 5) can be used, with the pitch angle and width corresponding to specified LB pitch angle and width.

Step 2. Cutting Operation with Machine Setup

A cutting machine is configured, based on the chosen pre-curved workpiece and target LB specifications. The cutting parameters include:

Cutting blade material: The material selection (e.g., metal, water jet, laser, plasma) aligns with the LB material and should be specified in the LB specifications.

Cutting blade angle: For tubular workpieces, the cutting blade angle is set to match the specified LB pitch angle. The width of the cut slices should also match the intended LB width.

For helical wrappers, the wrap segment length should be equal to the total LB length as specified.

### Step 3: LB Creation Via Cutting

The pre-curved workpiece undergoes a single cutting operation using the configured cutting machine, transforming it into slices having the final LB form.

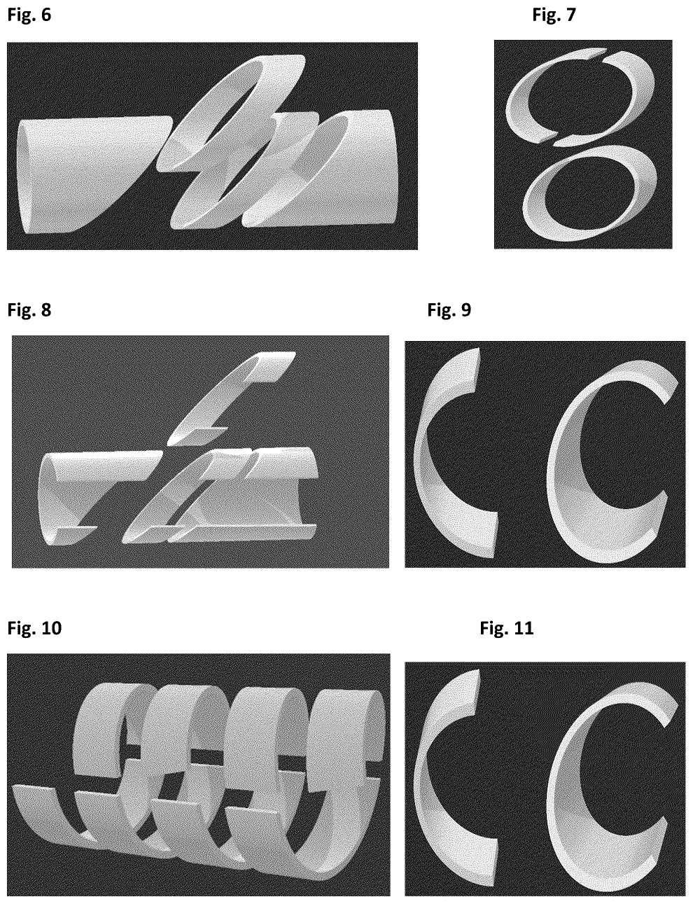

FIG. 6 Illustrates a closed pipe after cutting. FIG. 7 depicts the resulting closed LB and a pair of semi-LBs obtained from the cut pipe.

FIG. 8 shows an open pipe with cut out slices. FIG. 9 shows a semi-loop and a partial loop blades from an open pipe.

FIG. 10 illustrates segmented cuts of a helical stripe. FIG. 11 showcases obtainable partial and semi-LBs from the segmented helical stripe.

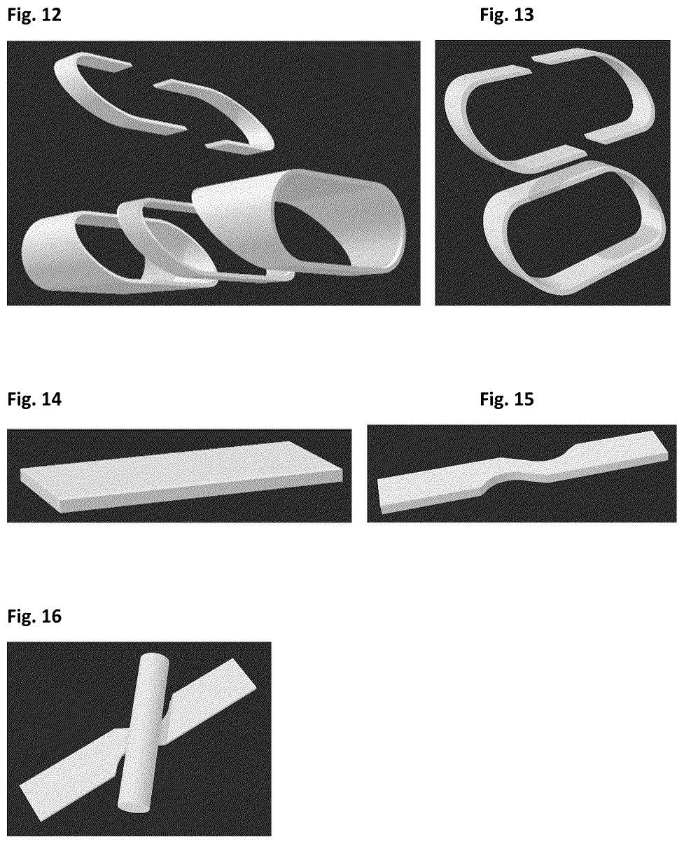

FIG. 12 depicts sliced off oval pipe. FIG. 13 shows the resulting oval closed LB and a pair of semi-LBs derived from the oval pipe.

### Method 2: Utilizing Pre-Cut Workpieces

The second method focuses on pre-cut flat sheets or bars as starting materials. These pre-cut elements offer advantages when creating LBs with straight wings.

### Step 1: Selection of Pre-Cut Workpiece

The selection of a pre-cut workpiece considers the desired LB specifications, including:
Material, length, width, and thickness of the bar, as specified in the LB specifications.
Pre-cut shape of the bar (plain—FIG. 14 or narrow tip—FIG. 15), also derived from the LB specifications.

Curving fixture cylinder diameter and angle, corresponding to the LB pitch angle obtained from the specifications.

Flat sheets or bars can be chosen based on these parameters.

### Step 2: Curving Operation

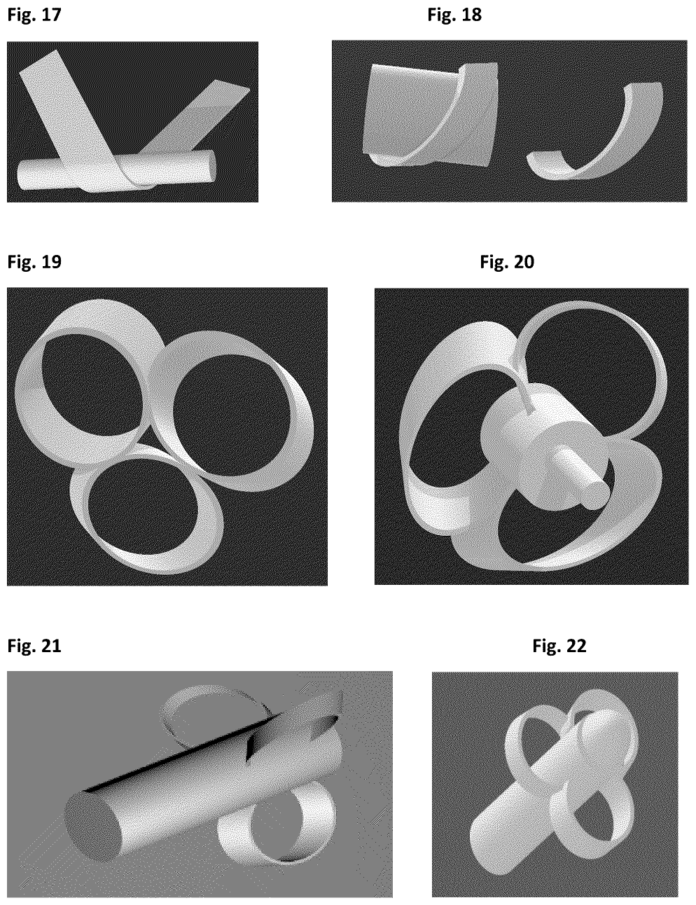

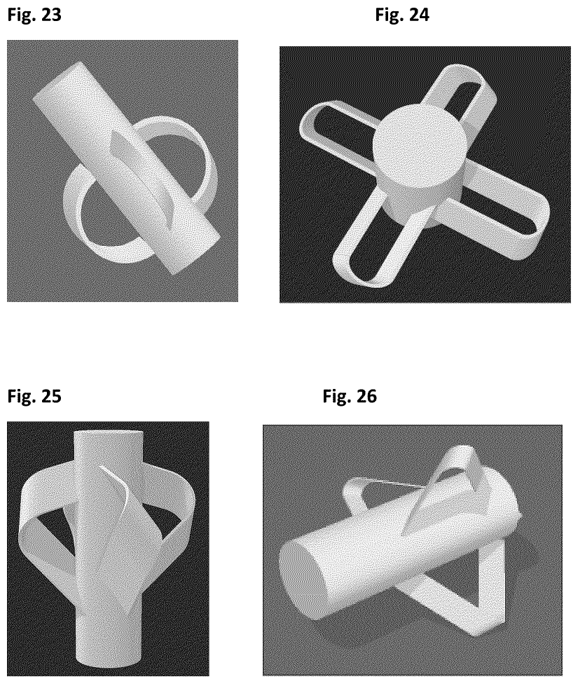

A curving/bending machine performs the process. The pre-cut bar wings are wrapped helically around a cylindrical fixture positioned at the LB pitch angle, given in the LB specifications (FIG. 16). FIG. 17 illustrates a resulting LB with straight wings. Depending on the wing length and cylinder diameter, this method produces partial and semi-loop LB (FIG. 18).

### Advantages

Both methods offer advantages over conventional LB production methods by: Utilizing readily available prefabricated materials, minimizing procurement lead times and costs.

Requiring only a single processing step (cutting or curving), simplifying production and reducing cycle times.

Tailoring the process based on LB specifications, ensuring precise dimensional control and repeatability.

### USE CASE EXAMPLES

The Loop Blades (LB) attach to propeller hub in different configurations. Depending on their shape and attachment, they may have particular advantages. For example, the straight wings (long or short) have more thrust, but the pressure on the blade distributes unequally along its length. Partial loop blades have arch greater than semi-loop blades for better flexibility for coaxial arrangements (assembled in a plane, where each loop axis is coaxial to the rotation axis). They derive from closed loop blades, from helical shape, via curving, etc. Semi-loop blades, derived from closed LBs, open LBs and helical LBs are interchangeable, provided all blade parameters are the same. Currently, there is a great variety of tubular shapes in production.

Here are some possible uses:

FIG. 19 Depicts closed LBs, assembled in coaxial way. This way their sides are mutually parallel at the point of touch, which provides greater bonding area between them;

FIG. 20 Shows closed loop blades attached in coaxial way to a propeller hub;

FIG. 21 Shows closed loop blades, attached to propeller hub, where each loop axis is perpendicular to the rotation axis (perpendicular way);

FIG. 22 Depicts partial open LBs, attached to propeller hub in perpendicular way;

FIG. 22 Shows semi-loop blades, attached to propeller hub in perpendicular way;

FIG. 24 Shows oval semi-loop blades, attached to propeller hub in coaxial way;

FIG. 25 Shows curved winged semi-LBs, attached hub in perpendicular way;

FIG. 26 Shows curved long-winged semi-loop blades, attached to propeller hub in perpendicular way.

1. (canceled)

2. (canceled)

3. (canceled)

4. A method for manufacturing a loop blade for a propeller, comprising: selecting a pre-curved workpiece based on target loop blade specifications; configuring a cutting machine based on the target loop blade specifications; and performing a single cutting operation on the pre-curved workpiece to create the loop blade, wherein the pre-curved workpiece is selected from the group consisting of a closed pipe, an open pipe, an oval pipe, and a helical wrapper, wherein the target loop blade specifications include at least one of a diameter, wall thickness, pitch angle, and width, wherein configuring the cutting machine includes setting a cutting blade angle to match a specified loop blade pitch angle, and wherein the loop blade created is selected from the group consisting of a closed loop blade, a semi-loop blade, and a partial loop blade.

5. A method for manufacturing a loop blade for a propeller, comprising: selecting a pre-cut flat workpiece based on target loop blade specifications; configuring a curving machine based on the target loop blade specifications; and performing a single curving operation on the pre-cut flat workpiece to create the loop blade, wherein the pre-cut flat workpiece is selected from the group consisting of a flat sheet and a bar, wherein the target loop blade specifications include at least one of material, length, width, thickness, and pitch angle, wherein configuring the curving machine includes setting a curving fixture cylinder diameter and angle corresponding to a specified loop blade pitch angle, and wherein the loop blade created may include straight wings.

6. A propeller comprising: a hub; and a plurality of loop blades attached to the hub, wherein each loop blade is manufactured by a method comprising: selecting a pre-fabricated workpiece based on target loop blade specifications; configuring a processing machine based on the target loop blade specifications; and performing a single operation on the pre-fabricated workpiece to create the loop blade, wherein the pre-fabricated workpiece is either a pre-curved workpiece or a pre-cut flat workpiece, wherein when the pre-fabricated workpiece is a pre-curved workpiece, the processing machine is a cutting machine and the single operation is a cutting operation, wherein when the pre-fabricated workpiece is a pre-cut flat workpiece, the processing machine is a curving machine and the single operation is a curving operation, and wherein the plurality of loop blades are attached to the hub in either a coaxial configuration or a perpendicular configuration.
